(19) United States
(12) Patent Application Publication
(10) Pub. No.: US 2011/0034364 A1
(43) Pub. Date: Feb. 10, 2011

(54) Color-Protecting Detergent or Cleanser

(76) Inventors: Birgit Gluesen, Duesseldorf (DE); Thomas Eiting, Duesseldorf (DE); Stefan van der Burgh, Tiel (NL); Matthias Sunder, Duesseldorf (DE)

Correspondence Address: Henkel Corporation, 10 Finderne Avenue, Suite B, Bridgewater, NJ, 08807, US

(21) Appl. No.: 12/905,125

(22) Filed: Oct. 15, 2010

Related U.S. Application Data
(63) Continuation of application No. PCT/EP2009/054278, filed on Apr. 9, 2009.

(30) Foreign Application Priority Data
Apr. 17, 2008 (DE) 10 2008 019 443.3

(51) Int. Cl. C11D 17/00; C11D 7/32

(52) U.S. Cl. 510/297; 428/402; 510/513; 510/360; 510/295

(57) ABSTRACT

Improved color protection of detergents and cleansers used for washing or cleaning colored textile fabrics is provided with use of porous polyamide particles in the detergent or cleanser.

### CROSS-REFERENCE TO RELATED APPLICATIONS

The present application is a continuation of International Patent Application No. PCT/EP2009/054278 filed 9 Apr. 2009, which claims priority to German Patent Application No. 10 2008 019 443.3 filed 17 Apr. 2008, both of which are incorporated herein by reference.

The present invention relates to the use of porous polyamide particles as dye-transfer inhibiting active ingredients in washing and/or cleaning textiles, as well as washing or cleaning agents containing such compounds.

In addition to ingredients such as surfactants and builders that are essential for the washing or cleaning process, washing and cleaning agents generally contain additional components which may be grouped together under the heading of washing auxiliaries. These include various groups of active ingredients such as foam regulators, graying inhibitors, bleaching agents, bleach activators and enzymes

Auxiliary substances also include substances for preventing dyed textiles from having a modified color appearance after washing. This change in color appearance of washed (i.e., clean) textiles may be due in part to proportions of the dye being removed from the textile by the washing or cleaning process (“fading”), as well as to dyes dissolved out from differently colored textiles that are then deposited on the textile (“discoloration”). Change due to discoloration may also involve undyed items of washing if these are washed together with colored items of washing.

In order to avoid these undesired side-effects of removing dirt from textiles by treatment with conventional surfactant-containing aqueous systems, washing agents, especially those intended as “color” washing agents for washing colored textiles, often contain active ingredients intended to prevent the dissolution of dyes from the textile or at least the redeposition of dissolved-out dyes present in the washing liquor onto textiles. However, many of the conventionally used polymers, which are typically water-soluble, have such a high affinity for dyes that they tend to draw them from the dyed fiber, resulting in color losses when they are used. Moreover, many conventional dye transfer inhibitors only act on some classes of dyes and do not prevent the transfer of other classes of dyes.

It has now surprisingly been found that porous polyamide particles lead to unexpectedly high levels of dye transfer inhibition when used in washing agents. The preventive action against staining of white or differently colored textiles by dyes washed out of the textiles is particularly pronounced. It is conceivable that the polymer particles, due to their large surface area, which in particularly preferred cases may be of dendritic structure or comprise fractal geometry, absorb dye molecules detached from the dyed fabrics and do not release them again, thereby preventing the redeposition of those dyes onto white or other colored textiles.

The present invention provides the use of porous polyamide particles which exhibit—
a number-average particle diameter of 1 to 30 μm,
a BET specific surface area (to DIN 66131) of 5 m²/g or more,
an oil absorption capacity (boiled linseed oil) of 160 ml/100 g or more,
a crystallinity (DSC measurement) of 40% or above, and
a quotient of volume-average particle diameter to number-average particle diameter of 1.0 to 1.5,
   in order to avoid the transfer or redeposition of textile dyes from dyed textiles onto undyed or differently colored textiles when they are jointly washed in particular surfactant-containing aqueous solutions.

Such porous polyamide particles may in general be produced by mixing a solution of polyamide in a suitable solvent with a liquid phase in which the polyamides are insoluble. The liquid phase is conventionally water-based, it being possible by means of suitable further solvents to ensure that, on mixing of the liquids, a clear solution is initially obtained, from which the polyamide particles precipitate. Mixture ratios of polyamide solution to liquid phase of 1:999 to 300:700, preferably of 2:998 to 250:750, have in particular proved effective during production.

Polyamide solutions can be prepared, for example, with the solvents o-cresol, m-cresol, p-cresol, chlorophenol, phenol or mixtures thereof. Formic acid has also proved effective.

The liquid phase in which polyamides are insoluble is preferably miscible with the above-stated solvents and furthermore water-miscible. Preferred liquid phases include aliphatic alcohols, aliphatic ketones and mixtures thereof. Methanol, ethanol, n-propanol, isopropanol, acetone, methyl ethyl ketone, methyl isopropyl ketone, methyl isobutyl ketone and mixtures thereof have proven particularly effective.

Mixtures of 10 to 98 wt. % of aliphatic alcohols and/or ketones with 2 to 90 wt. % of water can preferably be used as the liquid phase from which the polyamide particles precipitate. The liquid phase can contain high molecular weight polyalkylene glycols such as PEG or PPG in quantities of, for example, 0.5 to 10 wt. % (relative to the liquid phase) for nucleation.

The mixing sequence is not critical to the production method. In preferred methods—
aliphatic alcohols and/or ketones and water are added simultaneously but separately from one another to a polyamide solution, or
a previously prepared mixture of aliphatic alcohols and/or ketones and water is added to a polyamide solution, or
aliphatic alcohols and/or ketones are added to a polyamide solution, after which water is added, or
water is added to a polyamide solution, after which aliphatic alcohols and/or ketones are added, or
a polyamide solution is added to a previously prepared mixture of aliphatic alcohols and/or ketones and water, or
a polyamide solution is added to aliphatic alcohols and/or ketones and water and then water is added.

Formation of the porous polyamide particles by precipitation generally occurs in about 1 second up to about 2 hours, and may be assisted by stirring. Mixing of the liquids and formation of the particles preferably proceed at temperatures of 5 to 70° C., particularly preferably at 15 to 60° C.

After the above-stated period, the polyamide particles can be separated from the solvent mixture by decanting, filtration or centrifugation. Washing with methanol and/or acetone and drying under a vacuum are then preferably performed.

Very particularly preferred production methods use a solution of polyamide 11 and/or polyamide 12 in phenol, which, relative to the weight thereof, contains 0.1 to 50 wt. % of the polyamide(s). The liquid phase used in such preferred methods is a mixture of ethanol (preferably 50 to 90 wt. % relative to the liquid phase), ethylene glycol (preferably 1 to 10 wt. %, relative to the liquid phase) and glycerol (preferably 1 to 12 wt. % relative to the liquid phase). The polyamide solution in phenol (preferably 30 to 70 wt. % relative to the mixture), the liquid phase (preferably 40 to 65 wt. % relative to the mixture) and polyethylene glycol and/or polypropylene glycol with molar masses of >1000 Dalton (preferably 0.5 to 10 wt. % relative to the mixture) are stirred together to form a mixture containing 0.05 to 20 wt. % of polyamide(s). This mixture, which ideally exhibits a viscosity of about 200 Pa·s or less, is stirred for 30 to 60 minutes at 20 to 80° C., preferably at 25 to 65° C.

The spherical porous polyamide particles produced by the above-described methods and are used in preferred developments of the invention conventionally have number-average particle diameters of 0.1 μm to 100 μm, preferably 0.3 μm to 50 μm, particularly 0.5 μm to 25 μm. The ratio of volume-average particle diameter (Dv) to number-average particle diameter (Dn), which is also designated as the particle size distribution index (PDI=Dv/Dn), is preferably in the range from 1.0 to 1.3.

Porous polyamide particles have a BET specific surface area (to DIN 66131) of 5 m²/g or more. Particularly preferred particles according to the invention exhibit a BET specific surface area (to DIN 66131) of 5 m²/g to 80 m²/g, preferably 6 m²/g to 60 m²/g, and in particular 7.5 m²/g to 50 m²/g. Very particularly preferred developments of the invention include porous polyamide particles which exhibit a BET specific surface area (to DIN 66131) of 6 m²/g or more, preferably of 7 m²/g or more and in particular of 8 m²/g or more.

Preferred porous polyamide particles have a porosity index RI (RI=S/SO, in which SO is the specific surface area, based on number-average particle diameter, and [determined] by the formula SO=6/(ρ×Dn) in which ρ is the density of the particle and Dn the number-average particle diameter, and in which S is the BET specific surface area) in the range from 3 to 100, in particular in the range from 5 to 70.

The porous polyamide particles have an average pore diameter of 0.01 μm to 0.20 μm, in particular 0.02 μm to 0.1 μm, and a crystallinity (DSC measurement) of 40% or above.

The standard enthalpy (or specific heat of fusion) of the porous polyamide particles is measured by means of DSC. The sample is here heated under a nitrogen atmosphere starting from room temperature (20° C.) at a rate of temperature rise of 5° C./min. Standard enthalpy is calculated from the area of the heat absorption peaks from 120° C. to 230° C. Crystallinity of the porous polyamide particles is the quotient of the measured specific heat of fusion and standard enthalpy of the crystalline polyamide, the latter amounting to approximately 209 J/g for polyamide 12.

With regard to the oil absorption capacity of the particles used in agents according to the invention, preferred agents are those in which the porous polyamide particles exhibit an oil absorption capacity (boiled linseed oil) of 160 ml/100 g or more, preferably 170 ml/100 g or more.

The production of porous polyamide particles is also disclosed, for example, in Japanese published patent application 2002-80629. The porous polyamide particles are preferably spherical.

The porous polyamide particles may be added separately to the washing solution in the context of a manual or machine washing or cleaning method. They are preferably brought into contact with the textile as a component of a pretreatment agent in a step upstream from the actual washing operation or are preferably introduced into the washing solution as an ingredient of a washing or cleaning agent. The porous polyamide particles also have their positive action when used in the post-rinsing cycle in which textile-softening active ingredients are typically used. They may also be used in a laundry pre-treatment step, in which case the particulate polymer then preferably remains on the textile to be washed or passes together therewith into the washing liquor.

The present invention accordingly also provides a color-protecting washing, laundry pre-treatment, laundry post-treatment or cleaning agent containing a dye transfer inhibitor in the form of above-defined porous polyamide particles in addition to conventional ingredients compatible with this component.

An agent according to the invention preferably contains 0.05 wt. % to 20 wt. %, in particular from 0.1 wt. % to 5 wt. %, of such porous polyamide particles.

The stated active ingredients make a contribution to both of the above-mentioned aspects of color consistency (i.e., they reduce both discoloration and fading), although the staining prevention effect, in particular when washing white textiles, is most pronounced. The present invention accordingly also provides a method of using porous polyamide particles as defined above for avoiding the modification of the color appearance of textiles when they are washed in aqueous solutions, in particular surfactant-containing aqueous solutions. Modification of the color appearance should not be taken to mean the difference between the dirty and the clean textile, but rather the color difference between the clean textile in each case before and after the washing operation.

The present invention also provides a method for washing dyed textiles in surfactant-containing aqueous solutions comprising using a surfactant-containing aqueous solution containing the above-defined porous polyamide particles. In such a method it is also possible to wash white or undyed textiles together with the dyed textile without the white or undyed textile being stained.

In addition to the stated dye transfer inhibiting active ingredient, an agent according to the invention can additionally contain a known dye transfer inhibitor, preferably in quantities of 0.01 wt. % to 5 wt. %, in particular 0.1 wt. % to 1 wt. %, said inhibitor preferably being a polymer of vinylpyrrolidone, vinylimidazole, vinylpyridine N-oxide or copolymer thereof. Not only are polyvinyl pyrrolidones with molar weights of 15,000 to 50,000 usable, but so are polyvinyl pyrrolidones with molar weights of about 1,000,000 or greater, in particular 1,500,000 to 4,000,000, N-vinylimidazole/N-vinylpyrrolidone copolymers, polyvinyl oxazolidones, polyamine N-oxide polymers, polyvinyl alcohols and copolymers based on acrylamidoalkenylsulfonic acids.

It is also possible to use enzymatic systems comprising a peroxidase and hydrogen peroxide or a substance which liberates hydrogen peroxide in water. The addition of a mediator compound for the peroxidase, for example, an acetosyringone, a phenol derivative or a phenothiazine or phenoxazine, is preferred, with it also being possible to use the above-stated conventional polymeric dye transfer inhibitor active ingredients. For use in agents according to the invention, polyvinylpyrrolidone preferably has an average molar mass in the range from 10,000 to 60,000, in particular from 25,000 to 50,000. Preferred copolymers are those prepared from vinylpyrrolidone and vinylimidazole in the molar ratio 5:1 to 1:1 having an average molar mass in the range from 5000 to 50,000, in particular 10,000 to 20,000.

Washing agents according to the invention can be solid or liquid, and in particular assume the form of pulverulent solids, post-compacted particles, homogeneous solutions or suspensions. These agents can, in addition to the porous polyamide particles used according to the invention, contain any ingredients known and conventionally used in such agents. Agents according to the invention may in particular contain builder substances, surface-active surfactants, bleaching agents based on organic and/or inorganic peroxy compounds, bleach activators, water-miscible organic solvents, enzymes, sequestering agents, electrolytes, pH regulators and further auxiliary materials, such as optical brighteners, graying inhibitors, foam regulators together with colorants and scents. It is also possible according to the invention to apply the porous polyamide particles onto a water-insoluble cloth or to introduce them, optionally with one or more of the conventional ingredients, into a pouch which is sealed on all sides and made from a water-insoluble but water-permeable material, thereby allowing them to be used as an additive in the washing operation, if desired repeatedly, in particular twice, three times or four times. As an alternative to the latter-stated embodiment, the porous polyamide particles or agents containing the particles can be introduced into the washing process packaged in portions in a water-soluble material such as a polyvinyl alcohol film.

Agents according to the invention may contain one surfactant or two or more surfactants, the surfactants being not only anionic surfactants, nonionic surfactants and mixtures thereof, but also cationic, zwitterionic and amphoteric surfactants.

Suitable nonionic surfactants include alkylglycosides and ethoxylation and/or propoxylation products of alkylglycosides or linear or branched alcohols, each having 12 to 18 C atoms in the alkyl moiety and 3 to 20, preferably 4 to 10, alkyl ether groups. Corresponding ethoxylation and/or propoxylation products of N-alkylamines, vicinal diols, fatty acid esters and fatty acid amides, which correspond with regard to the alkyl moiety to the stated long-chain alcohol derivatives, and alkylphenols having 5 to 12 C atoms in the alkyl residue may furthermore be used.

Preferably used nonionic surfactants include alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as they are usually present in oxo alcohol residues. In particular, however, alcohol ethoxylates with linear residues prepared from alcohols of natural origin with 12 to 18 C atoms (e.g., from coconut, palm, tallow fat or oleyl alcohol) and averaging 2 to 8 EO per mol of alcohol are preferred. Preferred ethoxylated alcohols include, for example, C₁₂-C₁₄ alcohols with 3 EO or 4 EO, C₉-C₁₁ alcohols with 7 EO, C₁₃-C₁₅ alcohols with 3 EO, 5 EO, 7 EO or 8 EO, C₁₂-C₁₄ alcohols with 3 EO, 5 EO or 7 EO and mixtures of these, such as mixtures of C₁₂-C₁₄ alcohol with 3 EO and C₁₂-C₁₈ alcohol with 7 EO. The stated degrees of ethoxylation are statistical averages which, for a specific product, may be an integer or a fractional number. Preferred alcohol ethoxylates have a narrow homologue distribution (narrow range ethoxylates, NRE).

In addition to these nonionic surfactants, fatty alcohols with more than 12 PO may also be used. Examples of these are (tallow) fatty alcohols with 14 EO, 16 EO, 20 EO, 25 EO, 30 EO or 40 EO. In particular in agents for use in machine washing, extremely low-foam compounds are conventionally used. These preferably include C₁₂-C₁₈ alkyl polyethylene glycol/polypropylene glycol ethers, each having up to 8 mol of ethylene oxide and propylene oxide units per molecule. It is, however, also possible to use other nonionic surfactants which are known to be low-foaming, such as C₁₂-C₁₈-alkylpolyethylene glycol/polybutylene glycol ethers with up to 8 mol ethylene oxide and butylene oxide units per molecule and end group-terminated alkylpolyalkylene glycol mixed ethers. Alkoxylated alcohols containing hydroxyl groups as described in European patent application EP 0 300 305, or “hydroxy mixed ethers”, are also particularly preferred.

Alkyl glycosides of the general formula RO(G)ₓ, in which R means a primary straight-chain or methyl-branched aliphatic residue, in particular methyl-branched in position 2, with 8 to 22, preferably 12 to 18 C atoms and G denotes a glycose unit with 5 or 6 C atoms, preferably glucose, may also be used as nonionic surfactants. The degree of oligomerization x, which indicates the distribution of monoglycosides and oligoglycosides, is any desired number (which, being an analytically determined variable, may also assume fractional values) between 1 and 10; x is preferably 1.2 to 1.4.

Polyhydroxyfatty acid amides according to formula (I) below are likewise suitable, in which R¹CO is an aliphatic acyl residue with 6 to 22 carbon atoms, R² is hydrogen, an alkyl or hydroxyalkyl residue with 1 to 4 carbon atoms, and [Z] is a linear or branched polyhydroxyalkyl residue with 3 to 10 carbon atoms and 3 to 10 hydroxyl groups—

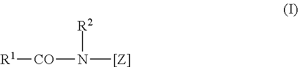

Polyhydroxy fatty acid amides are preferably derived from reducing sugars with 5 or 6 carbon atoms, in particular from glucose. Polyhydroxy fatty acid amides also include compounds according to formula (II) —

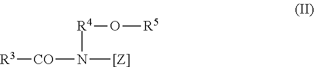

in which R³ is a linear or branched alkyl or alkenyl residue with 7 to 12 carbon atoms, R⁴ is a linear, branched or cyclic alkylene residue or an arylene residue with 2 to 8 carbon atoms and R⁵ is a linear, branched or cyclic alkyl residue or an aryl residue or an oxyalkyl residue with 1 to 8 carbon atoms, wherein C₁-C₄ alkyl or phenyl residues are preferred, and [Z] is a linear polyhydroxyalkyl residue, the alkyl chain of which is substituted with at least two hydroxyl groups, or alkoxylated, preferably ethoxylated or propoxylated derivatives of this residue. [Z] is also preferably obtained by reductive amination of a sugar such as glucose, fructose, maltose, lactose, galactose, mannose or xylose. N-alkoxy- or N-aryloxy-substituted compounds can then be converted into the desired polyhydroxy fatty acid amides by reaction with fatty acid methyl esters in the presence of an alkoxide catalyst.

A further class of preferably used nonionic surfactants which may be used either as sole nonionic surfactant or in combination with other nonionic surfactants, in particular together with alkoxylated fatty alcohols and/or alkylglycosides, comprises alkoxylated, preferably ethoxylated or ethoxylated and propoxylated fatty acid alkyl esters, preferably with 1 to 4 carbon atoms in the alkyl chain, in particular fatty acid methyl esters. Nonionic surfactants of the amine oxide type (e.g., N-coconut alkyl-N,N-dimethylamine oxide and N-tallow alcohol-N,N-dihydroxyethylamine oxide) and of the fatty acid alkanolamide type may also be suitable. The quantity of these nonionic surfactants preferably amounts to no more than that of the ethoxylated fatty alcohols, in particular no more than half the quantity thereof.

“Gemini” surfactants may also be considered as further surfactants. These are generally taken to mean such compounds as have two hydrophilic groups per molecule. These groups are generally separated from one another by a “spacer”. This spacer is generally a carbon chain which should be long enough for the hydrophilic groups to be sufficiently far apart that they can act mutually independently. Such surfactants are in general distinguished by an unusually low critical micelle concentration and the ability to bring about a great reduction in the surface tension of water. In exceptional cases, gemini surfactants include not only such “dimeric” surfactants, but also corresponding “trimeric” surfactants. Suitable gemini surfactants include sulfated hydroxy mixed ethers or dimer alcohol bis- and trimer alcohol tris-sulfates and -ether sulfates. End group-terminated dimeric and trimeric mixed ethers are distinguished in particular by their di- and multifunctionality. End group-terminated surfactants accordingly exhibit good wetting characteristics and are low-foaming, such that they are in particular suitable for use in machine washing or cleaning methods. Gemini polyhydroxyfatty acid amides or poly-polyhydroxyfatty acid amides may, however also be used. The sulfuric acid monoesters of linear or branched C₇-C₂₁ alcohols ethoxylated with 1 to 6 mol of ethylene oxide are also suitable, such as 2-methyl-branched C₉-C₁₁ alcohols with on average 3.5 mol of ethylene oxide (EO) or C₁₂-C₁₈ fatty alcohols with 1 to 4 EO.

Preferred anionic surfactants also include the salts of alkylsulfosuccinic acid, also known as sulfosuccinates or sulfosuccinic acid esters, and are the monoesters and/or diesters of sulfosuccinic acid with alcohols, preferably fatty alcohols and in particular ethoxylated fatty alcohols. Preferred sulfosuccinates contain C₈ to C₁₈ fatty alcohol residues or mixtures thereof. Particularly preferred sulfosuccinates contain a fatty alcohol residue derived from ethoxylated fatty alcohols, which are in themselves nonionic surfactants. Sulfosuccinates whose fatty alcohol residues are derived from ethoxylated fatty alcohols with a narrow homologue distribution are here particularly preferred. It is likewise also possible to use alk(en)ylsuccinic acid with preferably 8 to 18 carbon atoms in the alk(en)yl chain or the salts thereof.

Further anionic surfactants which may be considered are fatty acid derivatives of amino acids, for example of N-methyltaurine (taurides) and/or of N-methylglycine (sarcosides). Sarcosides or sarcosinates are particularly preferred here, especially sarcosinates of higher and optionally mono- or polyunsaturated fatty acids such as oleyl sarcosinate.

Further anionic surfactants which may in particular be considered are soaps. Saturated fatty acid soaps are in particular suitable, such as the salts of lauric acid, myristic acid, palmitic acid, stearic acid, hydrogenated erucic acid and behenic acid and in particular soap mixtures derived from natural fatty acids, for example, coconut, palm kernel or tallow fatty acids. Known alkenylsuccinic acid salts may also be used together with these soaps or as substitutes for soaps.

Anionic surfactants including the soaps can be present in the form of the sodium, potassium or ammonium salts thereof and as soluble salts of organic bases such as mono-, di- or triethanolamine. The anionic surfactants are preferably present in the form of the sodium or potassium salts, in particular the sodium salts.

Surfactants are present in washing agents according to the invention in proportions of preferably 5 wt. % to 50 wt. %, in particular of 8 wt. % to 30 wt. %.

An agent according to the invention preferably contains at least one water-soluble and/or water-insoluble organic and/or inorganic builder. Water-soluble organic builder substances include polycarboxylic acids, in particular citric acid and saccharic acids, monomeric and polymeric aminopolycarboxylic acids, in particular methylglycinediacetic acid, nitrilotriacetic acid and ethylenediaminetetraacetic acid together with polyaspartic acid, polyphosphonic acids, in particular aminotris(methylenephosphonic acid), ethylenediaminetetrakis(methylenephosphonic acid) and 1-hydroxyethane-1,1-diphosphonic acid, polymeric hydroxyl compounds such as dextrin and polymeric (poly-)carboxylic acids, in particular the polycarboxylates accessible by oxidizing polysaccharides or dextrins, polymeric acrylic acids, methacrylic acids, maleic acids and copolymers thereof, which may also contain small proportions of polymerizable substances without carboxylic acid functionality incorporated by polymerization. The relative molecular mass of the homopolymers of unsaturated carboxylic acids is typically from 3000 to 200,000, that of the copolymers from 2000 to 200,000, preferably 30,000 to 120,000, in each case relative to free acid. One particularly preferred acrylic acid/maleic acid copolymer has a relative molecular mass of 30,000 to 100,000. Conventional commercial products include Sokalan® CP 5, CP 10 and PA 30 from BASF. Suitable although less preferred compounds of this class include copolymers of acrylic acid or methacrylic acid with vinyl ethers, such as vinyl methyl ethers, vinyl esters, ethylene, propylene and styrene, the acid fraction of which amounts to at least 50 wt. %.

Terpolymers containing as monomers two unsaturated acids and/or the salts thereof and, as third monomer, vinyl alcohol and/or an esterified vinyl alcohol or a carbohydrate may also be used as water-soluble organic builder substances. The first acidic monomer or the salt thereof is derived from a monoethylenically unsaturated C₃-C₈ carboxylic acid and preferably from a C₃-C₄ monocarboxylic acid, in particular from (meth)acrylic acid. The second acidic monomer or the salt thereof may be a derivative of a C₄-C₈ dicarboxylic acid, maleic acid being particularly preferred, and/or a derivative of an allylsulfonic acid which is substituted in position 2 with an alkyl or aryl residue. Such polymers generally have a relative molecular mass of from 1000 to 200,000. Further preferred copolymers are those which preferably comprise acrolein and acrylic acid/acrylic acid salt or vinyl acetate as monomers. The organic builder substances may be used, in particular for producing liquid agents, in the form of aqueous solutions, preferably in the form of 30 to 50 wt. % aqueous solutions. All the stated acids are typically used in the form of their water-soluble salts, in particular alkali metal salts.

Such organic builder substances may, if desired, be present in quantities of up to 40 wt. %, in particular up to 25 wt. % and preferably 1 wt. % to 8 wt. %. Quantities close to the stated upper limit are preferably used in pasty or liquid, particularly water-containing agents according to the invention.

Water-soluble inorganic builder materials include alkali metal silicates, alkali metal carbonates and alkali metal phosphates, which may be present in the form of the alkaline, neutral or acidic sodium or potassium salts thereof. Examples include trisodium phosphate, tetrasodium diphosphate, disodium dihydrogendiphosphate, pentasodium triphosphate, “sodium hexametaphosphate”, oligomeric trisodium phosphate with degrees of oligomerization of 5 to 1000, in particular 5 to 50, and the corresponding potassium salts or mixtures of sodium and potassium salts. Water-insoluble, water-dispersible inorganic builder materials which are used are in particular crystalline or amorphous alkali metal aluminosilicates, in quantities of up to 50 wt. %, preferably of no more than 40 wt. % and, in liquid agents, in particular from 1 wt. % to 5 wt. %. Preferred such materials are crystalline sodium aluminosilicates of washing agent grade, in particular zeolite A, P and optionally X, alone or in mixtures, for example in the form of a co-crystallization product of zeolites A and X (Vegobond® AX, a commercial product from Condea Augusta S.p.A). Quantities close to the stated upper limit are preferably used in solid, particulate agents. Suitable aluminosilicates comprise no particles with a grain size above 30 μm and preferably consist to an extent of at least 80 wt. % of particles with a size below 10 μm. Their calcium binding capacity, which may be determined as stated in German patent DE 24 12 837, is generally in the range of from 100 to 200 mg of CaO per gram.

Suitable substitutes or partial substitutes for the aluminosilicate include crystalline alkali metal silicates, which may be present alone or mixed with amorphous silicates. Alkali metal silicates usable as builders in agents according to the invention preferably have a molar ratio of alkali metal oxide to SiO₂ of below 0.95, in particular 1:1.1 to 1:12, and may be in amorphous or crystalline form. Preferred alkali metal silicates are sodium silicates, in particular amorphous sodium silicates, with a molar ratio Na₂O:SiO₂ of 1:2 to 1:2.8. Preferably used crystalline silicates, which may be present alone or mixed with amorphous silicates, are crystalline phyllosilicates of the general formula Na₂SiₓO₂ₓ₊ᵢ.y H₂O, in which x, the “modulus”, is a number from 1.9 to 22, in particular 1.9 to 4 and y is a number from 0 to 33 and preferred values for x are 2, 3 or 4. Preferred crystalline phyllosilicates are those in which x in the stated general formula assumes the values 2 or 3. In particular, both β- and δ-sodium disilicates (Na₂Si₂O₅.yH₂O) are preferred. Virtually anhydrous crystalline alkali metal silicates, produced from amorphous alkali metal silicates, of the above-stated general formula in which x means a number from 1.9 to 2.1 may also be used in agents according to the invention.

A crystalline sodium phyllosilicate with a modulus of 2 to 3, as may be produced from sand and soda, is used in a further preferred embodiment of agents according to the invention.

Crystalline sodium silicates with a modulus in the range from 1.9 to 3.5 are used in a further preferred embodiment of agents according to the invention. Crystalline layered silicates of the above-stated formula (I) are sold by Clariant GmbH under the trade name Na-SKS, for example Na-SKS-1 (Na₂Si₂₂O₄₅xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₂₉.xH₂O, makatite). Of these Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaHSi₂O₅.3H₂O, kanemite), Na-SKS-11 (t-Na₂Si₂O₅) and Na-SKS-13 (NaHSi₂O₅) are particularly suitable, in particular however Na-SKS-6 (δ-Na₂Si₂O₅).

In a preferred development of agents according to the invention, a granular compound is used which is prepared from crystalline phyllosilicate and citrate, from crystalline phyllosilicate and above-stated (co)polymeric polycarboxylic acid or from alkali metal silicate and alkali metal carbonate, as is commercially available for example under the name Nabion® 15.

Builder substances are preferably present in agents according to the invention in quantities of up to 75 wt. %, in particular 5 wt. % to 50 wt. %.

Peroxy compounds suitable for use in agents according to the invention include organic peracids or peracid salts of organic acids such as phthalimidopercaproic acid, perbenzoic acid or salts of diperdodecanedioic acid, hydrogen peroxide and inorganic salts which release hydrogen peroxide under washing conditions, which latter include perborate, percarbonate, persilicate and/or persulfate such as caroate. When solid peroxy compounds are used, they may be used in the form of powders or granules, which may also be encapsulated in known manner. If an agent according to the invention contains peroxy compounds, these are preferably present in quantities of up to 50 wt. %, in particular of 5 wt. % to 30 wt. %. It may be appropriate to add small quantities of known bleaching agent stabilizers such as phosphonates, borates or metaborates and metasilicates and magnesium salts such as magnesium sulfate.

Bleach activators which may be used are compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Preferred compounds are repeatedly acylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol ester and acetylated sorbitol and mannitol or the described mixtures thereof (SORMAN), acylated sugar derivatives, in particular pentaacetyl glucose (PAG), pentaacetyl fructose, tetraacetyl xylose and octaacetyl lactose and acetylated, optionally N-alkylated glucamine and gluconolactone, and/or N-acylated lactams, for example, N-benzoylcaprolactam. The hydrophilically substituted acyl acetals and acyl lactams are likewise preferably used. Combinations of conventional bleach activators may also be used. Such bleach activators may be present, in particular in the presence of the above-stated hydrogen peroxide-releasing bleaching agents, in a conventional quantity range, preferably in quantities of 0.5 wt. % to 10 wt. %, in particular 1 wt. % to 8 wt. %, relative to the total agent, but are preferably entirely absent when percarboxylic acid is used as the sole bleaching agent.

In addition to or instead of conventional bleach activators, sulfone imines and/or bleach-boosting transition metal salts or transition metal complexes may also be present as “bleach catalysts”.

Enzymes usable in the agents include those from the class of amylases, proteases, lipases, cutinases, pullulanases, hemicellulases, cellulases, oxidases, laccases and peroxidases and mixtures thereof. Particularly suitable enzymatic active ingredients include those obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus. The enzymes may be adsorbed onto carrier substances and/or be embedded in encapsulating substances in order to protect them from premature inactivation They are present in washing or cleaning agents according to the invention preferably in quantities of up to 5 wt. %, in particular 0.2 wt. % to 4 wt. %. If the agent contains protease, it preferably exhibits a proteolytic activity in a range from approx. 100 PU/g to approx. 10,000 PU/g, in particular 300 PU/g to 8000 PU/g. If two or more enzymes are used in the agent according to the invention, this may be achieved by incorporating the two or more separate enzymes or enzymes which are separately formulated in known manner or by two or more enzymes jointly formulated in a granular product.

Organic solvents other than water which may be used in agents according to the invention, particularly those in liquid or pasty form, include alcohols with 1 to 4 C atoms, in particular methanol, ethanol, isopropanol and tert.-butanol, diols with 2 to 4 C atoms, in particular ethylene glycol and propylene glycol, and mixtures thereof and ethers derivable from the stated classes of compounds. Such water-miscible solvents are preferably present in agents according to the invention in quantities of no more than 30 wt. %, in particular of 6 wt. % to 20 wt. %.

In order to establish a desired pH value which is not automatically obtained by mixing the remaining components, agents according to the invention may contain acids compatible with the system and environmentally compatible, in particular citric acid, acetic acid, tartaric acid, malic acid, lactic acid, glycolic acid, succinic acid, glutaric acid and/or adipic acid, as well as mineral acids, in particular sulfuric acid, or bases, in particular ammonium or alkali metal hydroxides. Such pH regulators are present in the agents according to the invention in quantities of preferably no more than 20 wt. %, in particular of 1.2 wt. % to 17 wt. %.

Graying inhibitors keep dirt which has been dissolved away from the textile fiber suspended in the liquor. Water-soluble colloids of a mainly organic nature are suitable for this purpose, for example starch, size, gelatin, salts of ether carboxylic acids or ether sulfonic acids of starch or cellulose or salts of acidic sulfuric acid esters of cellulose or starch. Water-soluble polyamides containing acidic groups are also suitable for this purpose. Derivatives of starch other than those stated above, for example aldehyde starches, may further be used. Cellulose ethers, such as carboxymethylcellulose (Na salt), methylcellulose, hydroxyalkylcellulose and mixed ethers, such as methylhydroxyethylcellulose, methylhydroxypropylcellulose, methylcarboxymethylcellulose and mixtures thereof, are preferably used, for example in quantities of 0.1 to 5 wt. % relative to the agents.

Textile washing agents according to the invention can contain derivatives of diaminostilbene disulfonic acid or the alkali metal salts thereof as optical brighteners, although they preferably contain no optical brighteners for use as a color washing agent. Suitable compounds include salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Brighteners of the substituted diphenylstyryl type may furthermore be present, for example the alkali metal salts of 4,4′-bis(2-sulfostyryl)-diphenyl, 4,4′-bis(4-chloro-3-sulfostyryl)-diphenol, or 4-(4-chlorostyryl)-4′-(2-sulfostyryl)-diphenyl. Mixtures of the above-stated optical brighteners may also be used.

Especially in machine washing methods, it may be advantageous to add conventional foam inhibitors to the agents. Suitable foam inhibitors include soaps of natural or synthetic origin having an elevated proportion of C₁₈-C₂₄ fatty acids. Suitable non-surfactant foam inhibitors include organopolysiloxanes and mixtures thereof with microfine, optionally silanized silica, as well as paraffins, waxes, microcrystalline waxes and mixtures thereof with silanized silica or bis-fatty acid alkylenediamides. Mixtures of different foam inhibitors are also advantageously used, for example, mixtures of silicones, paraffins or waxes. Foam inhibitors, in particular foam inhibitors containing silicone and/or paraffin, are preferably bound to a granular carrier substance which is soluble or dispersible in water. Mixtures of paraffins and bistearylethylenediamide are particularly preferred here.

To improve the aesthetic appearance of the agents, they may be dyed with suitable dyes. Preferred dyes, the selection of which will cause a person skilled in the art no difficulty, have elevated storage stability and are insensitive to the other ingredients in the agents and to light and, in the event of use in textile washing agents, have no marked substantivity relative to textile fibers, so as not to dye these.

The production of solid agents according to the invention presents no difficulties and may proceed in known manner, for example, by spray drying or granulation, with enzymes and any further thermally sensitive ingredients such as bleaching agents optionally being added separately. Agents according to the invention with an elevated bulk density, in particular in the range from 650 g/l to 950 g/l, may preferably be produced by a method comprising an extrusion step.

Agents according to the invention may preferably be produced in the form of tablets, which may be monophasic or multiphasic, single-colored or multicolored. The tablets can have one or two or more layers, in particular two layers, by mixing together all the components, optionally for each layer, in a mixer and compression molding the mixture by means of conventional tablet presses, for example, eccentric presses or rotary presses with pressing forces in the range from approx. 50 to 100 kN, preferably 60 to 70 kN. For multilayer tablets, it may be advantageous for at least one layer to be preliminarily compression molded. This is preferably carried out at pressing forces of from 5 to 20 kN, in particular 10 to 15 kN. In this manner, break-resistant tablets are obtained which still dissolve sufficiently rapidly under use and exhibit breaking and flexural strength values typically from 100 to 200 N, preferably above 150 N. A tablet produced in this manner is preferably of a weight of 10 g to 50 g, in particular 15 g to 40 g. The tablets may be of any desired three-dimensional shape and may be round, oval or polygonal, intermediate shapes also being possible. Corners and edges are advantageously rounded. Round tablets preferably have a diameter of 30 mm to 40 mm. In particular, the size of polygonal or cuboidal tablets, which are most commonly introduced, for example, by a dispenser of a dishwashing machine, is dependent on the geometry and volume of this dispenser. Preferred embodiments have, for example, a base area of (20 to 30 mm)ₓ(34 to 40 mm), in particular 26×36 mm or of 24×38 mm.

Liquid or pasty agents according to the invention in the form of solutions containing conventional solvents, in particular water, are generally produced by simply mixing the ingredients, which may be introduced into an automatic mixer as an undissolved material or as a solution.

### EXAMPLES

A Staining Scale Rating (SSR), based on ISO 105-A04, was carried out to determine the dye transfer inhibiting properties of the individual washing agents. To this end, two white fabrics (A: 6×16 cm standard cotton fabric wfk; B: 6×16 cm standard polyamide fabric) were washed at 60° C. in a Linitest apparatus with a color former (1: Acid Blue 113; 2: Disperse Red 60; 3: Disperse Blue 79), the concentration of which in the washing liquor was 3 g/l (color former 1) or 10 g/l (color formers 2 and 3) using a washing agent composition containing no dye transfer inhibitor (rate of addition 5.0 g/l) and with addition of (I) 1 g/l or (II) 10 g/l of porous polyamide particles, then rinsed with water and hung up to dry at room temperature. The degree of discoloration of the two fabrics was then determined by spectrophotometry. Moreover, by way of comparison, the washing agent composition W containing no dye transfer inhibitor was tested in the same manner without addition of polyamide particles.

The degree of discoloration was then stated in values from 1 (severe discoloration) to 5 (no discoloration).

From the SSR values shown in the following tables, it is clear that agents according to the invention exhibit better dye transfer inhibiting properties than the formulation without the dye transfer inhibitor active ingredient—

### Cotton Fabric—

| Color former | W | W + I | W + II |
|---|---|---|---|
| 1 | 4.5 | 4.7 | 4.9 |
| 2 | 4.8 | n.d. | 4.9 |
| 3 | 4.0 | 4.1 | 4.7 |

### Polyamide Fabric—

| Color former | W | W + I | W + II |
|---|---|---|---|
| 1 | 1.9 | 2.7 | 4.5 |
| 2 | 3.4 | 3.7 | 4.4 |
| 3 | 2.6 | 2.7 | 3.9 |

We claim:

1. Washing, laundry pre-treatment, laundry post-treatment or cleaning agent comprising a dye transfer inhibitor in the form of porous polyamide particles having
a number-average particle diameter of 1 to 30 μm,
a BET specific surface area (to DIN 66131) of 5 m²/g or more,
an oil absorption capacity (boiled linseed oil) of 160 ml/100 g or more,
a crystallinity (DSC measurement) of 40% or above, and
a quotient of volume-average particle diameter to number-average particle diameter of 1.0 to 1.5.

2. Agent according to claim 1, wherein the porous polyamide particles are present in an amount of 0.05 wt. % to 20 wt. %, based on total weight of the agent.

3. Agent according to claim 1, wherein the porous polyamide particles are applied onto a water-insoluble cloth.

4. Agent according to claim 1 further comprising a pouch containing the porous polyamide particles, wherein the pouch is sealed on all sides and made from a water-insoluble but water-permeable material.

5. Agent according to claim 1 further comprising a polymer of vinylpyrrolidone, vinylimidazole, vinylpyridine N-oxide or a copolymer thereof.

7. Agent according to claim 1, wherein the spherical porous polyamide particles have a number-average particle diameter of 0.1 μm to 100 μm.

8. Agent according to claim 1, wherein the ratio of volume-average particle diameter (Dv) to number-average particle diameter (Dn) of the porous polyamide particles, also designated as the particle size distribution index (PDI=Dv/Dn), is in a range of from 1.0 to 1.3.

9. Agent according to claim 1, wherein the porous polyamide particles have a BET specific surface area (to DIN 66131) of 5 m²/g to 80 m²/g.

10. Agent according to claim 1, wherein the porous polyamide particles have a porosity index RI in the range from 3 to 100.

11. Agent according to claim 1, wherein the porous polyamide particles have an average pore diameter of 0.01 μm to 0.20 μm and a crystallinity (DSC measurement) of 40% or above.

12. Method of preventing the transfer of textile dyes from dyed textiles onto undyed or differently colored textiles when they are jointly washed comprising washing dyed textiles together with undyed and/or differently colored textiles in surfactant-containing aqueous solutions comprising porous polyamide particles having
a number-average particle diameter of 1 to 30 μm,
a BET specific surface area (to DIN 66131) of 5 m²/g or more,
an oil absorption capacity (boiled linseed oil) of 160 ml/100 g or more,
a crystallinity (DSC measurement) of 40% or above, and
a quotient of volume-average particle diameter to number-average particle diameter of 1.0 to 1.5.
